(19) United States
(12) Patent Application Publication
(10) Pub. No.: US 2007/0052775 A1
(43) Pub. Date: Mar. 8, 2007

(54) Gas purging unit and inkjet head having the same

(75) Inventor: Myung-song Jung, Gunpo-si (KR)

Correspondence Address: STANZIONE & KIM, LLP, 919 18TH STREET, N.W., SUITE 440, WASHINGTON, DC, 20006, US

(73) Assignee: SAMSUNG Electronics, Suwon-si (KR)

(21) Appl. No.: 11/501,838

(22) Filed: Aug. 10, 2006

(30) Foreign Application Priority Data
Sep. 6, 2005 (KR) 2005-82626

(51) Int. Cl. B41J 2/175

(52) U.S. Cl. 347/86

(57) ABSTRACT

A gas purging unit and an inkjet head with the same. The gas purging unit has an exhaust chamber with a connecting hole to communicate with an ink passage and an exhaust hole that communicates with an outside. A gas permeable membrane is installed at the connecting hole. A negative pressure generator is provided inside the exhaust chamber to operate through an external force and generate a negative pressure with less pressure than a pressure inside the ink passage. A check valve is installed at the exhaust hole to open the exhaust hole when the external force operates the negative pressure generator and to close the exhaust hole by a force of the negative pressure after the external force is removed.

### CROSS-REFERENCE TO RELATED APPLICATIONS

This application claims the benefit of Korean Patent Application No. 10-2005-0082626, filed on Sep. 6, 2005, in the Korean Intellectual Property Office, the disclosure of which is incorporated herein in its entirety by reference.

### BACKGROUND OF THE INVENTION

1. Field of the Invention

The present general inventive concept relates to a gas purging unit to outwardly purge gas from ink and to an inkjet head having the same.

2. Description of the Related Art

Gas inherent in ink has a tendency to expand with a temperature fluctuation (from low to high temperatures) or a pressure change (from high to low pressure). The gas is mostly air and small quantities of gases derived from the ingredients in the ink. When there is an absence of a device, such as a gas purging unit, that absorbs the expanded volume of gas and controls the pressure of ink inside ink passages when gas expands, an amount of ink equivalent to the volume of gas that has expanded flows out through a nozzle of an inkjet printhead. Such superfluously discharged ink either creates unwanted stains on paper or distorts the direction of ink ejection when printing.

A cartridge with a printhead, an ink refill needle, and a vacuum needle is disclosed in U.S. Pat. No. 5,905,518, which is hereby incorporated by reference. Coupled to an ink tank is a vacuum chamber with a spring bag structure to create a vacuum. The ink tank is provided with an ink refill septum, and the vacuum chamber is provided with a vacuum septum. When the ink tank is attached to the cartridge, the ink refill needle passes through an ink refill septum and connects to the ink tank to supply ink to the printhead, whereupon the vacuum needle passes through the vacuum septum to connect with the vacuum chamber.

During printing, air that enters through the nozzle of the printhead, air inherent in the ink, and other gaseous ingredients expand as gas bubbles due to an increase in temperature or other causes. These gas bubbles collect around the vacuum needle to an air pocket. The gas collected in the air pocket is suctioned into the vacuum chamber through the vacuum needle. In this manner, the problem of gas expanding due to a rise in temperature or change in pressure and a resulting disruption in pressure equilibrium of ink supplied to the printhead causing ink leakage, is prevented.

When ink in the ink tank is depleted, the ink tank is removed from the cartridge. Here, the vacuum chamber coupled to the ink tank is also removed. When a new ink tank is installed on the cartridge, a vacuum chamber on the newly installed ink tank performs the operations described above.

During the replacing of the ink tank, if the vacuum needle and the vacuum septum are not thoroughly sealed, air enters the vacuum chamber and can render the pressure of the vacuum chamber insufficient to perform its operations. Also, if the volume of gas collected in the air pocket is small, excessive vacuum of the vacuum chamber prompts ink to flow through the vacuum needle into the vacuum chamber, rendering the vacuum chamber incapable of performing its operations and reducing the amount of ink that can be used for printing by the amount of ink suctioned into the vacuum chamber. Furthermore, because each ink tank requires a built-in vacuum chamber and vacuum membrane, production cost increases.

### SUMMARY OF THE INVENTION

The present general inventive concept provides a gas purging unit to effectively and reliably remove gas from a printhead and an ink passage extending from an ink tank to the printhead, and an ink head having the same.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing a gas purging unit to remove gas inside ink of an inkjet head having a printhead to eject the ink and an ink passage to connect the printhead with an ink tank containing the ink, the gas purging unit including: an exhaust chamber including a connecting hole to communicate with the ink passage and an exhaust hole to communicate with an outside; a gas permeable membrane installed at the connecting hole; a negative pressure generator provided inside the exhaust chamber to operate through an external force and generate a negative pressure in the exhaust chamber with less pressure than a pressure inside the ink passage; and a check valve installed at the exhaust hole to open the exhaust hole when the external force operates the negative pressure generator and to close the exhaust hole by the negative pressure after the external force is removed.

The foregoing and/or other aspects and utilities of the present general inventive concept are also achieved by providing an inkjet head including a printhead ejecting ink, an ink passage connecting the printhead with an ink tank containing ink, and a gas purging unit to remove gas from the ink, the gas purging unit including: an exhaust chamber including a connecting hole to communicate with the ink passage and an exhaust hole to communicate with an outside; a gas permeable membrane installed at the connecting hole; a negative pressure generator provided inside the exhaust chamber to operate through an external force and generate a negative pressure in the exhaust chamber with less pressure than a pressure inside the ink passage; and a check valve installed at the exhaust hole to open the exhaust hole when the external force operates the negative pressure generator and to close the exhaust hole by the negative pressure after the external force is removed.

The vacuum may be 80% of atmospheric pressure.

The external force may shrink the space to 80% or less of a maximum volume of the space.

The gas permeable membrane may be a membrane of a woven fiber membrane made of one of Teflon, nylon, and polyester and a vacuum foamed membrane of a polypropylene sulfide (PPS) material.

The exhaust chamber may further include an aperture to enable the external force to be applied to the negative pressure generator.

The negative pressure generator may include: a flexible shield forming a space between the connecting hole and the exhaust hole in the exhaust chamber; and an elastic member providing elasticity in a direction that increases a volume of the space, wherein the external force reduces the volume of the space and deforms the elastic member in a direction opposite to the elasticity of the elastic member and the elastic member rebounds to form a negative pressure inside the space.

The shield may be a film made of one of nylon, Teflon, PE, and PP and a film obtained by coating the film made of nylon, Teflon, PE, or PP with metal.

The foregoing and/or other aspects and utilities of the present general inventive concept are also achieved by providing an exhaust apparatus to exhaust gases out of an ink passage of a printhead, including a chamber; a first opening in the chamber to communicate with the ink passage and having a unidirectional membrane formed thereon to allow gas to flow in one direction from the ink passage to the exhaust apparatus; a second opening in the chamber to communicate externally to exhaust gases therefrom, the second opening having a one-way valve to open the second opening when a force is applied thereto to allow the gasses to pass out of the chamber and to close the second opening when the force is removed therefrom; and a pumping member to apply the force to the one-way valve, the force further providing a negative pressure within the chamber to draw gases from the ink passage to the chamber through the unidirectional membrane.

The pumping member may include a first member having a hard surface to receive an external force; a flexible portion extending from the outer region of the first member to inner walls of the chamber to create a vacuum space within the chamber; and an elastic member within the vacuum space and connected to a surface of the first member to apply a biasing force thereto when the external force is applied to the first member, the biasing force creating the negative pressure within the chamber.

The foregoing and/or other aspects and utilities of the present general inventive concept are also achieved by providing a method of removing gasses from an ink passage of a print head, the method including applying a negative pressure to a chamber to force air out of the chamber through a check valve to create a vacuum within the chamber; and releasing the negative pressure to the chamber to draw the gasses out of the ink passage and into the chamber through a gas permeable membrane disposed between the ink passage and the chamber.

It is possible that when the pressure is applied to the chamber the check valve becomes open to force the air out of the chamber, and when the pressure within the chamber become equal to the pressure outside the check valve closes, and when the pressure applied to the chamber is released the gasses from the ink passage are drawn into the chamber through the gas permeable membrane.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a sectional view of an embodiment of an inkjet head and gas purging unit of the present general inventive concept;

FIG. 2 is a sectional view illustrating the operation of the inkjet head and gas purging unit in FIG. 1;

FIG. 3 is a sectional view of an embodiment of a vacuum regulator;

FIG. 4 is a sectional view of another embodiment of an inkjet head and gas purging unit of the present general inventive concept; and

FIG. 5 is a sectional view of another embodiment of an inkjet head and gas purging unit of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

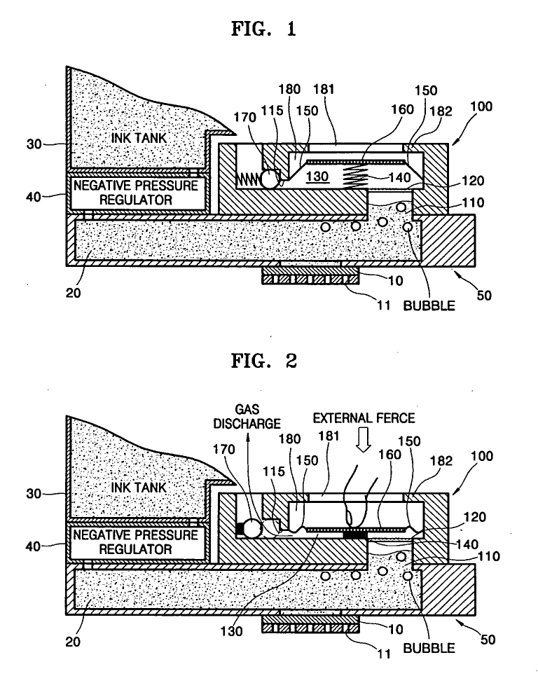

FIG. 1 is a sectional view of an embodiment of an inkjet head and gas purging unit of the present general inventive concept. Referring to FIG. 1, a cartridge 50 includes an ink passage 20 and a printhead 10. An ink tank 30 to store ink may be coupled to the cartridge 50. Alternately, the ink tank 30 may be connected to the ink passage 20 through an ink tube (not shown), instead of being coupled to the cartridge 50.

The printhead 10 has a plurality of nozzles 11 to discharge ink. The printhead 10 is provided with a chamber communicating through the plurality of nozzles 11 and having a discharging device (such as a piezo element or heater) to supply pressure to discharge ink, and a passage to supply ink to the chamber. Because such a chamber, discharging device, and passage are familiar to those skilled in the art, detailed descriptions thereof are omitted herein.

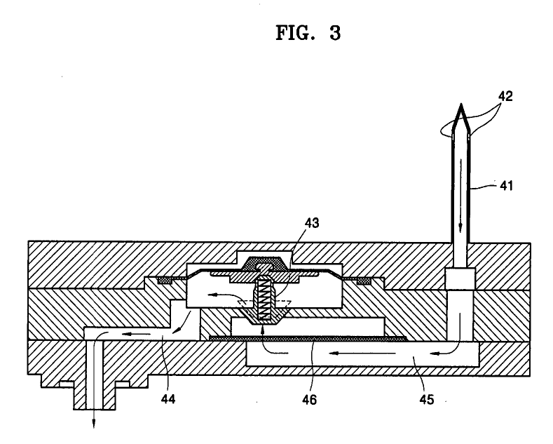

The ink is supplied from the ink tank 30 to the ink passage 20 through gravity by means of varying heights. Also, there may be a negative pressure regulator 40 interposed between the ink passage 20 and the ink tank 30. The negative pressure regulator 40 allows ink to flow freely from the ink tank 30 to the ink passage 20 by creating a vacuum when ink in the printhead 10 is depleted due to printing. The negative pressure regulator 40 has a structure such as the example illustrated in FIG. 3.

Referring to FIG. 3, the negative pressure regulator 40 can include a needle 41, an ink intake channel 45, a valve 43, and an ink discharge channel 44. The needle 41 can couple with the ink tank 30. Ink flows into needle through holes 42 and proceeds to the ink intake channel 45. The ink discharge channel 44 can be connected to the ink passage 20. The valve 43 is installed between the ink intake channel 45 and the ink discharge channel 44. The valve 43 operates due to an ink pressure difference between the ink intake channel 45 and the ink discharge channel 44. When ink is depleted in the printhead 10, a negative pressure proportional to the depleted volume of ink is formed. This negative pressure is applied to the ink discharge channel 44 through the ink passage 20. The negative pressure causes the valve 43 to operate and allow communication between the ink intake and discharge channels 45 and 44, respectively. The ink in the ink tank 30 passes through the needle 41 via the through holes 42, the ink intake channel 45, and the ink discharge channel 44 to enter the ink passage 20. The flow of ink causes a reduction in pressure difference between the ink intake channel 45 and ink discharge channel 44, so that the valve 43 operates to shut down communication between the ink intake channel 45 and the ink discharge channel 44. Reference number 46 signifies a filter to remove impurities from the ink. This structure enables ink to flow freely from the ink tank 30 to the printhead 10. When printing is not being conducted, the valve 43 closes the passage between the ink intake channel 45 and the ink discharge channel 44 to prevent ink leakage from the nozzle 11 of the printhead 10.

When the printhead 10 discharges ink according to a print signal, heat is generated, which raises the temperature of the ink. Accordingly, air flowing in through the nozzle 11 dissolves in the ink, and ingredients in the ink that are vaporized due to the dissolving of the air expand to create gas bubbles in the printhead 10 and the ink passage 20. In order to eliminate these bubbles, embodiments of the inventive inkjet head have a gas purging unit 100.

Referring again to FIG. 1, the gas purging unit 100 of the present embodiment includes an exhaust chamber 180, a gas permeable membrane 120, a negative pressure generator (described below), and a check valve 170. Provided in the exhaust chamber 180 is a connecting hole 110 to communicate with the ink passage 20 and an exhaust hole 115 to communicate with the outside. The gas permeable membrane 120 is disposed within the connecting hole 110. The gas permeable membrane 120 is a membrane that transmits gases, but not liquids, and may be a membrane formed of Teflon, nylon, or a polyester woven fiber, or a vacuum-foamed polypropylene sulfide (PPS) membrane. A representative gas permeable membrane 120 is GORTEX™. The check valve 170 is installed in the exhaust hole 115. The ink passage 20 is geometrically configured to allow the bubbles to move toward the connecting hole 110 by means of specific gravity difference between the bubbles and the ink. For example, although not illustrated in detail in the drawings, the ink passage 20 can be tilted upward toward the connecting hole 110.

The negative pressure generator generates a negative pressure that is less than the pressure in the ink passage 20 of the exhaust chamber 180. FIG. 1 illustrates an embodiment of a negative pressure generator. A shield 150 made of a flexible film forms a space 130 including the connecting hole 110 and the exhaust hole 115 inside the exhaust chamber 180. In order to prevent gas from the outside from entering the space 130 through a pressure inequality between the space 130 and the outside, the shield 150 may be a flexible film made of nylon, Teflon, PE, PP, or other high polymer. Also, a metal coating (aluminium, for example) may be applied to the film. An elastic member 140 provides elasticity in an expanding direction of the space 130. The negative pressure generator of this embodiment operates by means of an external force to create a negative pressure. For this purpose, the exhaust chamber 180 has an aperture 181 to allow an external force to be applied to the negative pressure generator. The aperture 181 in this embodiment is located on the wall 182 of the exhaust chamber 180 opposite to the printhead 10. An external force can be applied to the shield 150 in order to reduce the volume of the space 130. The elastic member 140 provides elasticity to the shield 150 in a direction that increases the volume of the space 130. In other words, the elastic member 140 creates a biasing force in a direction opposite to the external force applied to the shield 150. The negative pressure generator may further include an auxiliary member 160 to form the space 130 in conjunction with the shield 150. The auxiliary member 160 may be made of a material that is more rigid than the shield 150, and an external force may be applied to the auxiliary member 160 to reduce the volume of the space 130. The elastic member 140 rests against the auxiliary member 160 and provides elasticity to the auxiliary member 160 in a direction that increases the volume of the space 130. The check valve 170 opens the exhaust hole 115 when an applied external force reduces the space 130, and closes the exhaust hole 115 by means of a negative pressure created inside the space 130 when the external force is removed.

The pressure formed in the space 130 by the negative pressure generator may be lower than the pressure inside the ink passage 20. Additionally, because cabin pressure for airplanes is generally adjusted for 0.8 atm, the pressure of the space 130 may also be adjusted to 0.8 atm or less. In order to adjust the pressure of the space 130 to 0.8 atm or less, the elastic member 140 must have an appropriate elastic coefficient. When an inkjet head, used under normal atmospheric pressure, should board an aircraft with a cabin pressure of 0.8 atm, the pressure on the outside of the shield 150 and the auxiliary member 160 (that form a barrier between the space 130 and the outside) decreases 20%, thus expanding the space 130 and creating a corresponding loss in negative pressure. In order to prevent loss of negative pressure under such changes in atmospheric pressure, the amount of volume that the space 130 decreases through an application of external force may be 80% or less of the maximum volume of the space 130.

An explanation of the operation of the above structure will now be described.

In order to form a negative pressure in the exhaust chamber 180, an external force is applied to the shield 150 and/or the auxiliary member 160. The external force compresses the elastic member 140 and the gas inside the space 130. As illustrated in FIG. 2, the pressure causes the check valve 170 to open the exhaust hole 115. The gas inside the space 130 is expelled therefrom through the exhaust hole 115. When the pressure inside the space 130 becomes equal to the pressure outside, the check valve 170 closes the exhaust hole 115, as illustrated by the dotted line in FIG. 2. The elasticity provided by the elastic member 140 to the shield 150 or the auxiliary member 160 prompts the volume of the space 130 to increase, thereby forming a vacuum inside the space 130.

When air flows in through the nozzle 11 of the printhead 10, air is dissolved in the ink, and ingredients in the ink are vaporized and form bubbles through a temperature increase or an external drop in pressure. The formed bubbles pass through the ink passage 20 and converge towards the connecting hole 110. Negative pressure formed in the space 130 through the negative pressure generator has a lower pressure than the ink passage 20. Accordingly, the bubbles penetrate the gas permeable membrane 120 and enter the space 130. This effect allows a negation of pressure built up from the bubbles inside the ink passage 20 and the printhead 10, to prevent ink leakage through the nozzle 11. Furthermore, when the ink tank 30 is replaced, the shield 150 or the auxiliary member 160 is pressed to exert pressure on the gas inside the space 130. This pressure is evenly applied inside the space 130. The pressure causes the check valve 170 to open the exhaust hole 115. Although a certain amount of gas inside the space 130 may pass in a reverse direction through the gas permeable membrane 120 and enter the ink passage 20, this gas volume is exceedingly small. Most of the gas passes through the exhaust hole 115 to the outside. When the external force is removed, negative pressure is once again created in the space 130. The gas purging unit 100 in this embodiment can repeatedly expel gas and create negative pressure by means of an applied external force, so that it can be used semi-permanently until the cartridge 50 expires. Accordingly, compared to the conventional method of attaching a vacuum chamber to the ink tank, the manufacturing cost of the ink tank 30 can be reduced, as can a user's expenditures for replacement parts.

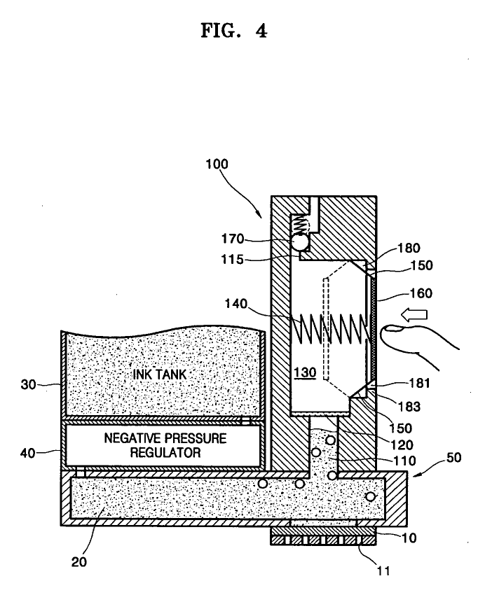

FIG. 4 is a sectional view of another embodiment of an inkjet head of the present general inventive concept, which is similar to the embodiment illustrated in FIG. 1, aside from the fact that the aperture 181 is provided at a sidewall 183 of the exhaust chamber 180 and the direction of applying pressure to the shield 150 (or the auxiliary member 160) for creating a vacuum is different.

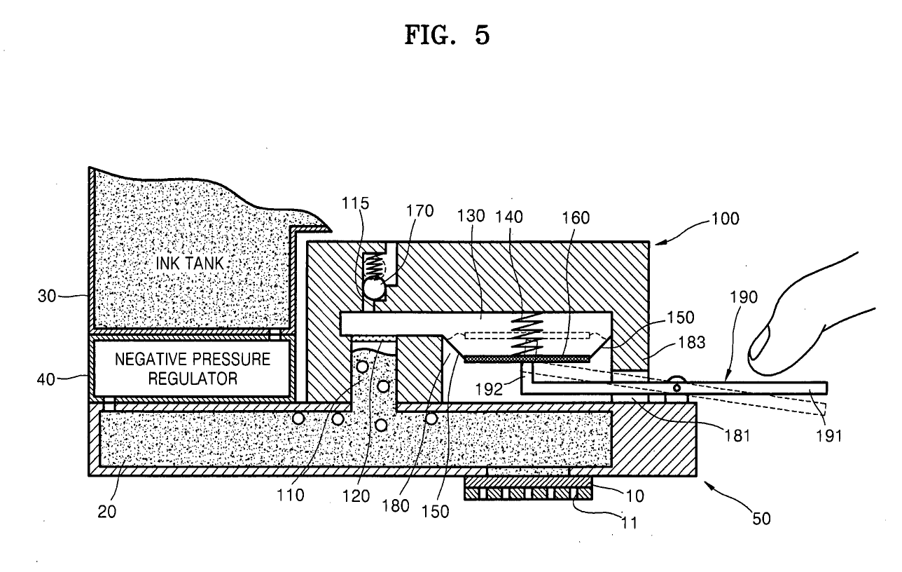

FIG. 5 is a sectional view of yet another embodiment of an inkjet head of the present general inventive concept, which is similar to the embodiment illustrated in FIG. 1, aside from the fact that the aperture 181 is provided at a sidewall 183 of the exhaust chamber 180 and the structure to apply an external force to the shield 150 (or the auxiliary member 160) to create a negative pressure is different. Referring to FIG. 5, one example of an external force applying structure includes is a lever 190. If an external force is applied to an end 191 of the lever 190, another end 192 of the lever 190 presses against the shield 150 (or the auxiliary member 160) to deform the elastic member 140 and create a vacuum in the space 130.

A user may press the shield 150 (or the auxiliary member 160) or the lever 190 with his/her hand or use an implement to expel gas from the space 130 and form a vacuum therein. When the ink tank 30 is connected to the ink passage 20 through an ink tube (not shown), or when the ink tank 30 is coupled to the cartridge 50 with the aperture 181 exposed to the outside, an external force is applied at predetermined intervals to the negative pressure generator through the aperture 181 to expel gas from the space 130 and maintain an adequate negative pressure therein. Gas can be expelled and negative pressure can be created as needed, especially when a large amount of bubbles are formed.

Also, while not illustrated in the diagrams, an external force generator may be added to the inkjet printer having the inkjet head of the present general inventive concept to provide the negative pressure generator with an external force. In this case, a user does not need to intervene, or can input settings to operate the external force generator depending on the operating process of the inkjet printer, in order to create a negative pressure in the space 130.

External force can also be applied to the negative pressure generator during the installation of the ink tank 30 to the cartridge 50.

The above-described gas purging unit 100 according to various embodiments of the present general inventive concept may be used on a shuttle-type inkjet head that prints an image by ejecting ink on the paper while moving back and forth in a perpendicular direction (main scanning direction) to the paper feeding direction (subsidiary scanning direction). The gas purging unit 100 according to various embodiments of the present general inventive concept may also be used on an array-type inkjet printhead that is disposed across the width of printing paper along a main scanning direction thereof.

The above-described inkjet head of the present general inventive concept provides utilities as follows.

By using a gas permeable membrane, reverse flow of ink into the gas purging unit can be prevented.

Further, because gas can be expelled and negative pressure can be created as often as needed by means of an external force, the gas purging units can be used semi-permanently, to reduce the cost of replacement parts.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet head comprising a printhead that ejects ink, an ink passage connecting the printhead with an ink tank containing ink, and a gas purging unit that removes gas from the ink, the gas pursing unit comprising:
an exhaust chamber including a connecting hole to communicate with the ink passage and an exhaust hole to communicate with an outside;
a gas permeable membrane to cover the connecting hole;
a negative pressure generator provided inside the exhaust chamber to operate through an external force and to generate a negative pressure in the exhaust chamber with less pressure than a pressure inside the ink passage; and
a check valve installed at the exhaust hole to open the exhaust hole when the external force operates the negative pressure generator and to close the exhaust hole by a force of the negative pressure after the external force is removed.

2. The inkjet head of claim 1, wherein the negative pressure generator generates a negative pressure of 80% or less of atmospheric pressure.

3. The inkjet head of claim 1, wherein the external force shrinks an inner space of the exhaust chamber to 80% or less of a maximum volume of the inner space.

4. The inkjet head of claim 1, wherein the gas permeable membrane is a woven fiber membrane made of one of Teflon, nylon, and polyester and a vacuum foamed membrane of a PPS (polypropylene sulfide) material.

5. The inkjet head of claim 1, wherein the exhaust chamber further includes an aperture to enable the external force to be applied to the negative pressure generator.

6. The inkjet head of claim 5, wherein the aperture is formed on a wall of the exhaust chamber opposite to the printhead.

7. The inkjet head of claim 5, wherein the aperture is formed on a sidewall of the exhaust chamber.

8. The inkjet head of claim 7, further comprising an external force generator to apply the external force through the aperture to the negative pressure generator.

9. The inkjet head of claim 1, wherein the negative pressure generator includes:
a flexible shield forming a space between the connecting hole and the exhaust hole in the exhaust chamber; and
an elastic member providing elasticity in a direction that increases a volume of the space, wherein the external force reduces the volume of the space and deforms the elastic member in a direction opposite to the elasticity of the elastic member and the elastic member rebounds to form a negative pressure inside the space.

10. The inkjet head of claim 9, wherein the negative pressure generator further includes an auxiliary member defining the space together with the shield and supporting the elastic member, the auxiliary member receiving the external force to reduce the volume of the space and deform the elastic member.

11. The inkjet head of claim 9, wherein the shield is a film made of one of nylon, Teflon, PE (polyethylene), and PP (polypropylene), and a film obtained by coating the film made of nylon, Teflon, PE, or PP with metal.

12. A gas purging unit to remove gas inside ink of an inkjet head having a printhead to eject the ink and an ink passage to connect the printhead with an ink tank containing the ink, the gas purging unit comprising:
an exhaust chamber including a connecting hole to communicate with the ink passage and an exhaust hole to communicate with an outside;
a gas permeable membrane to cover the connecting hole;
a negative pressure generator provided inside the exhaust chamber to operate through an external force and to generate a negative pressure in the exhaust chamber with less pressure than a pressure inside the ink passage; and
a check valve installed at the exhaust hole to open the exhaust hole when the external force operates the negative pressure generator and to close the exhaust hole by a force of the negative pressure after the external force is removed.

13. The gas purging unit of claim 12, wherein the negative pressure generator generates a negative pressure of 80% or less of atmospheric pressure.

14. The gas purging unit of claim 12, wherein the external force shrinks an inner space of the exhaust chamber to 80% or less of a maximum volume of the space.

15. The gas purging unit of claim 12, wherein the gas permeable membrane is a woven fiber membrane made of one of Teflon, nylon, and polyester and a vacuum foamed membrane made of a PPS (polypropylene sulfide) material.

16. The gas purging unit of claim 12, wherein the exhaust chamber further includes an aperture to enable the external force to be applied to the negative pressure generator.

17. The gas purging unit of claim 12, wherein the negative pressure generator includes:
a flexible shield and an auxiliary member forming an space between the connecting hole and the exhaust hole in the exhaust chamber; and
an elastic member providing elasticity in a direction that increases a volume of the space and supported by the auxiliary member, wherein the external force applied to the auxiliary member reduces the volume of the space and deforms the elastic member in a direction opposite to the elasticity of the elastic member and the elastic member rebounds to form a negative pressure inside the space.

18. The gas purging unit of claim 17, wherein the shield is a film made of one of nylon, Teflon, PE, and PP and a film obtained by coating the film made of nylon, Teflon, PE, or PP with metal.

19. An exhaust apparatus to exhaust gases out of an ink passage of a printhead, comprising:
a chamber;
a first opening in the chamber to communicate with the ink passage and having a uni-directional membrane formed thereon to allow gas to flow in one direction from the ink passage to the exhaust apparatus;
a second opening in the chamber to communicate externally to exhaust gases therefrom, the second opening having a one-way valve to open the second opening when a force is applied thereto to allow the gasses to pass out of the chamber and to close the second opening when the force is removed therefrom; and
a pumping member to apply the force to the one-way valve, the force further providing a negative pressure within the chamber to draw gases from the ink passage to the chamber through the unidirectional membrane.

20. The exhaust apparatus of claim 19, wherein the pumping member comprises:
a first member having a hard surface to receive an external force;
a flexible portion extending from the outer region of the first member to inner walls of the chamber to create a vacuum space within the chamber; and
an elastic member within the vacuum space and connected to a surface of the first member to apply a biasing force thereto when the external force is applied to the first member, the biasing force creating the negative pressure within the chamber.

21. The exhaust apparatus of claim 19, further comprising:
a third opening in the chamber to communicate externally and being closed by the flexible portion being attached to the inner walls of the chamber.

22. The exhaust apparatus of claim 20, further comprising:
a lever member extending between the chamber and the ink passage, the lever member being connected on one end to the first member such that when an opposite end thereof is pressed the external force is applied to the first member.

23. A method of removing gasses from an ink passage of a print head, the method comprising:
applying a negative pressure to a chamber to force air out of the chamber through a check valve to create a vacuum within the chamber; and
releasing the negative pressure to the chamber to draw the gasses out of the ink passage and into the chamber through a gas permeable membrane disposed between the ink passage and the chamber.

24. The method of claim 23, wherein when the pressure is applied to the chamber the check valve becomes open to force the air out of the chamber, and when the pressure within the chamber become equal to the pressure outside the check valve closes, and when the pressure applied to the chamber is released the gasses from the ink passage are drawn into the chamber through the gas permeable membrane.
